(19) United States
(12) Patent Application Publication
(10) Pub. No.: US 2015/0112594 A1
(43) Pub. Date: Apr. 23, 2015

(54) MOBILE CARRIER DEVICE CAPABLE OF IDENTIFYING LOCAL TEMPERATURE AND HUMIDITY AND METHOD THEREOF

(71) Applicant: Yuan Yu Chang, New Taipei City (TW)

(72) Inventor: Yuan Yu Chang, New Taipei City (TW)

(21) Appl. No.: 14/060,570

(22) Filed: Oct. 22, 2013

(51) Int. Cl. G01W 1/02; G01N 19/10; G01K 13/00

(52) U.S. Cl. CPC G01W 1/02; G01K 13/002; G01N 19/10
USPC 702/3

(57) ABSTRACT

Disclosed are a mobile carrier device capable of identifying local temperature and humidity and a method thereof. The device includes a temperature/humidity detection device mounted on a portable electronic device, a transfer module mounted in the portable electronic device, and a data processing module in information connection with the transfer module. The temperature/humidity detection device detects the surrounding temperature and humidity to generate personal temperature/humidity data, which is displayed via the transfer module on the portable electronic device, and transmits the personal temperature/humidity data to the data processing module. In response to the personal temperature/humidity data, the data processing module feeds suitable markup information corresponding thereto to the transfer module to be displayed on the portable electronic device. As such, the present invention achieves practical advantages of being easy to use and providing makeup advice fit to the environment and ensuring instantaneity and preciseness of temperature/humidity and weather information.

### (a) TECHNICAL FIELD OF THE INVENTION

The present invention generally relates to a mobile carrier device that is capable of identifying local temperature and humidity, and more particularly to a mobile carrier device that is easy to use and provides environment-fit makeup advice and is capable of identifying local temperature and humidity with preciseness and instantaneity of temperature and humidity and a method thereof.

### (b) DESCRIPTION OF THE PRIOR ART

With the progress and change of time, mobile phones become a must for daily living and are so popular that almost every person own one or more mobile phones. Statistic data reveals that the number of mobile phone numbers has exceeded the domestic population. It can be inferred that the ownership of mobile phone is as high as around 80 percent. With the progress of science and technology, the mobile phones are continuously evolved toward smart phones that have various functions.

Most of the smart phones include a weather module. The conventional weather module has to get linking to a weather agency to acquire weather information including temperature, rainfall rate, and daily weather for each local area. Further, some of the conventional weather module has a function of reminder that reminds a user to carry a rain gear or to supplement water. However, the conventional weather modules provide only rough weather information, which generally lacks of preciseness and instantaneity. Further, the weather information is provided only for outdoor environments. When a user is indoors, the surrounding environment is certainly different from the weather information so provided, not to mention when the indoor space is an enclosed space or when air-conditioning is in operation.

Thus, it is a challenge of the present inventor and the manufacturers of the industry to overcome the above discussed problems.

### SUMMARY OF THE INVENTION

In view of the above drawbacks, the present invention aims to provide a mobile carrier device that is easy to use and provides environment-fit makeup advice and is capable of identifying local temperature and humidity with preciseness and instantaneity of temperature and humidity and a method thereof.

The primary object of the present invention is easy operation and instantaneously providing suitable makeup advice that is fit to the environment.

Another object of the present invention is to provide precise and instant information of temperature and humidity.

To achieve the above objects, the present invention comprises an identification carrier and a portable electronic device in information connection with each other, wherein the identification carrier primarily comprises, in structure, a temperature/humidity detection device mounted on the portable electronic device. The portable electronic device receives a transfer module mounted therein and the transfer module is in information connection with the temperature/humidity detection device. The transfer module is further in information connection with a data processing module. In an operation of the present invention, the temperature/humidity detection device detects the surrounding temperature and humidity and generates personal temperature/humidity data. The personal temperature/humidity data is transmitted to the transfer module to be displayed on the portable electronic device and is further transmitted to the data processing module. The data processing module makes comparison according to the personal temperature/humidity data to generate makeup information that is fit to the environment in which a user is located and is displayed on the portable electronic device. With the above technique, the drawbacks of the known techniques that the conventional weather module lacks of preciseness and instantaneity and deviation from the surrounding environment of the user exists can be overcome to achieve the practical advantages of being easy to use, providing environment-fit make up advice, and ensuring instantaneity and preciseness of temperature/humidity and weather information.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a block diagram of a preferred embodiment of the present invention.

FIG. 2 is a flow chart illustrating the steps of a preferred embodiment of the present invention;

FIG. 3 is a perspective view of the preferred embodiment of the present invention.

FIG. 4 is a block diagram of another preferred embodiment of the present invention.

FIG. 5 is a perspective view of said another preferred embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

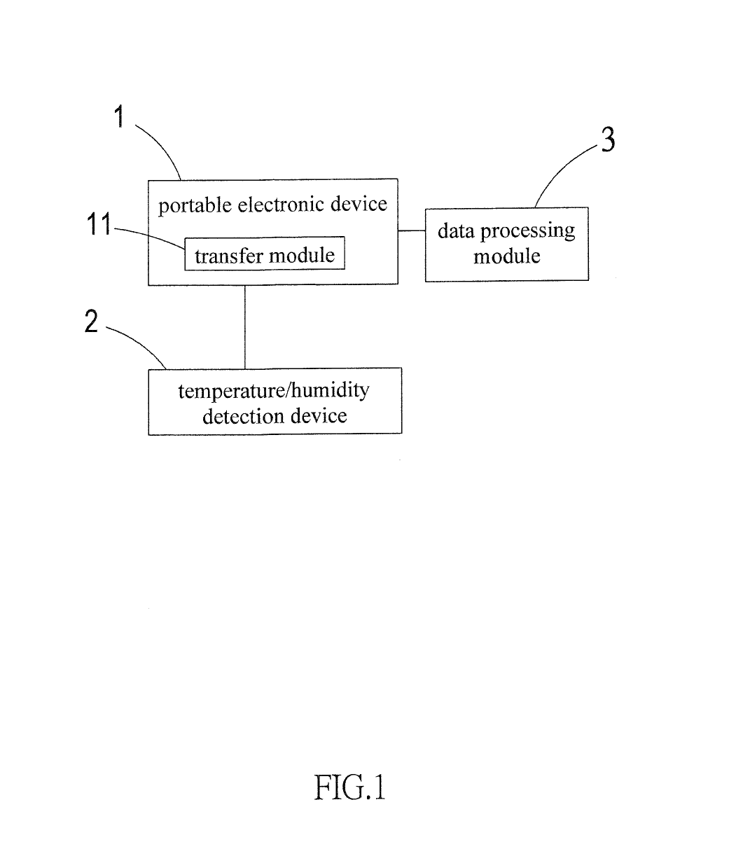

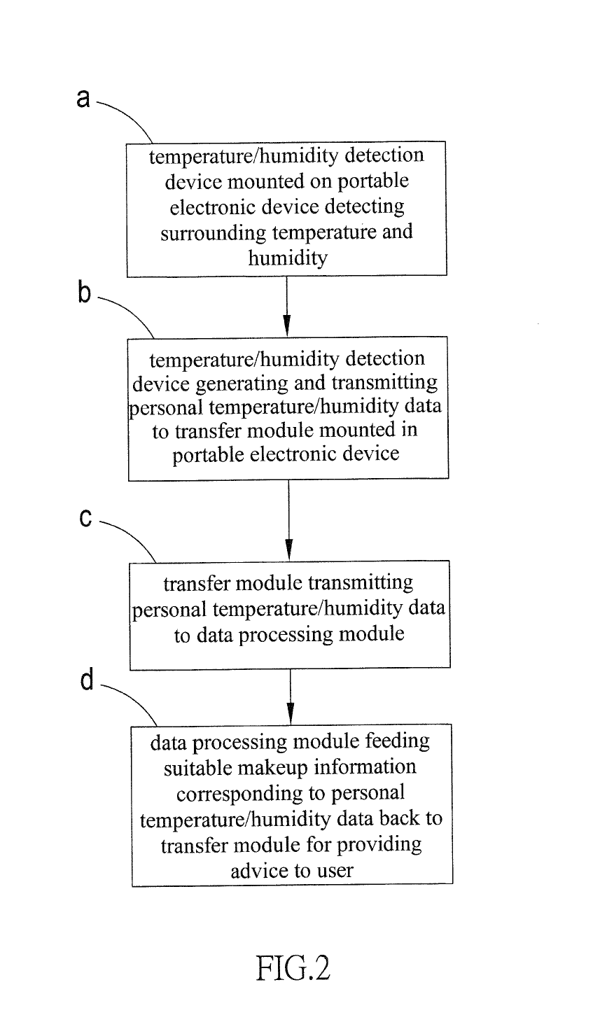

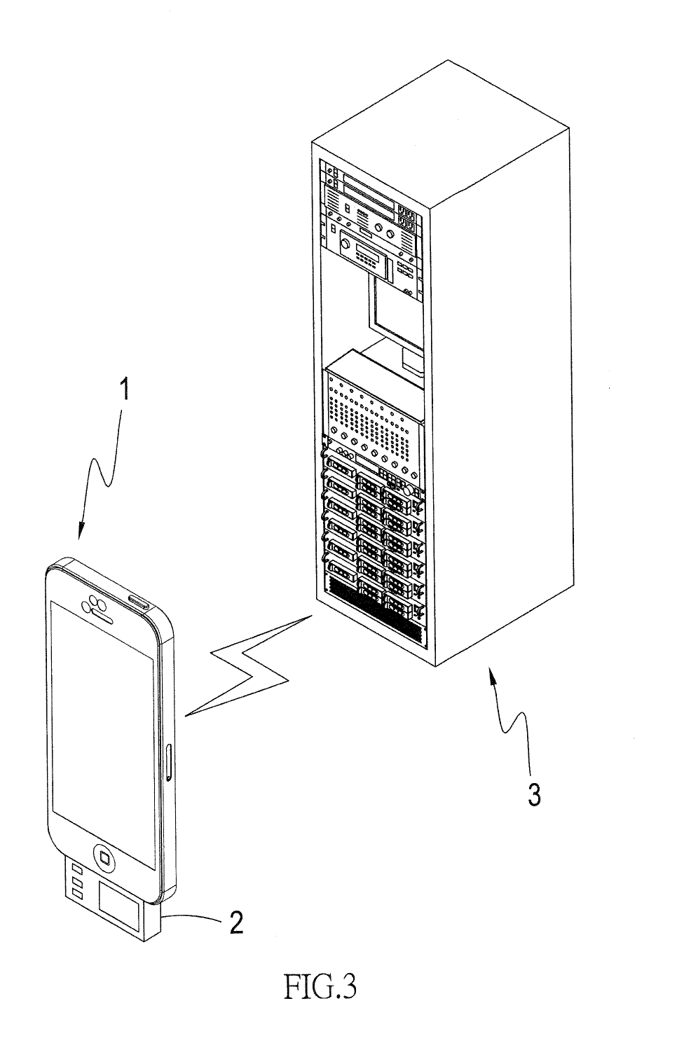

Referring to FIGS. 1-3, which are respectively a block diagram, a flow chart, and a perspective view of a preferred embodiment of the present invention, the drawings clearly show that the present invention primarily comprises an identification carrier and a portable electronic device 1 in information connection with each other. The identification carrier comprises a temperature/humidity detection device 2, a transfer module 11, and a data processing module 3. The temperature/humidity detection device 2 is mounted on the portable electronic device 1. The temperature/humidity detection device 2 functions to generate personal temperature/humidity data. The transfer module 11 is mounted in the portable electronic device 1. The transfer module 11 is set in information connection with the temperature/humidity detection device 2. The data processing module 3 receives the personal temperature/humidity data and feeds suitable makeup information corresponding to the personal temperature/humidity data back to the transfer module 11, whereby the transfer module 11 is enabled to directly display the personal temperature/humidity data on the portable electronic device 1 and is also allowed to display the makeup information of the data processing module 3 or temperature/humidity information. Further, the above is just an example way of practicing the present invention and the present invention is not limited thereto.

To use the present invention, the method is as follows:

(a) The temperature/humidity detection device mounted on the portable electronic device detects the surrounding temperature and humidity;

(b) The temperature/humidity detection device generates and transmits personal temperature/humidity data to the transfer module mounted in the portable electronic device;

(c) The transfer module transmits the personal temperature/humidity data to the data processing module; and

(d) The data processing module feeds suitable makeup information corresponding to the personal temperature/humidity data back to the transfer module for providing advice to a user.

This allows a user to get precisely aware of the temperature and humidity of the environment in which the user is located in an easy and personalized manner and to know what makeups can be used according to the current environment so as to keep the user health and beautiful.

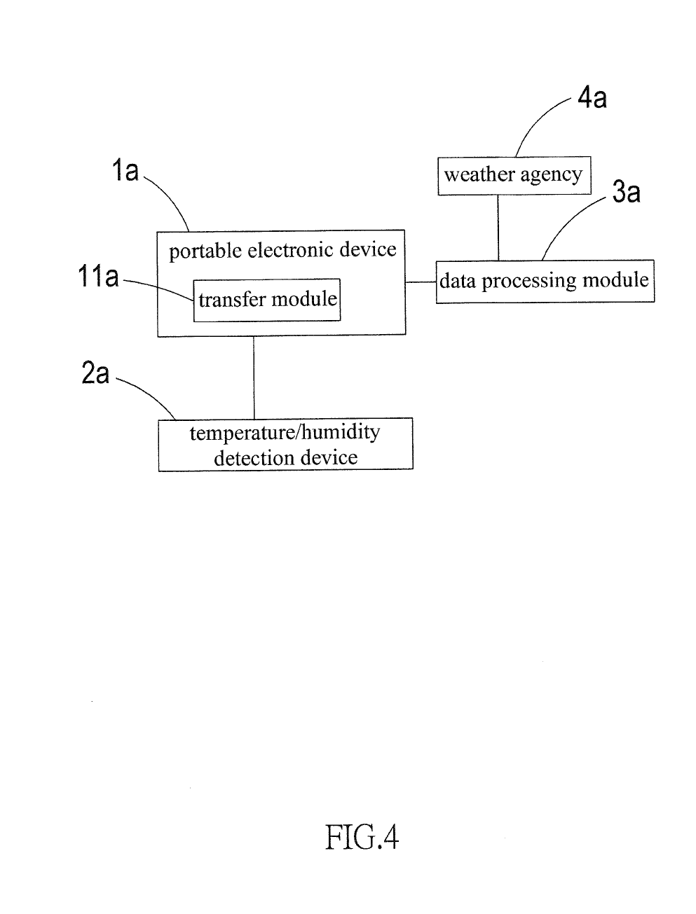

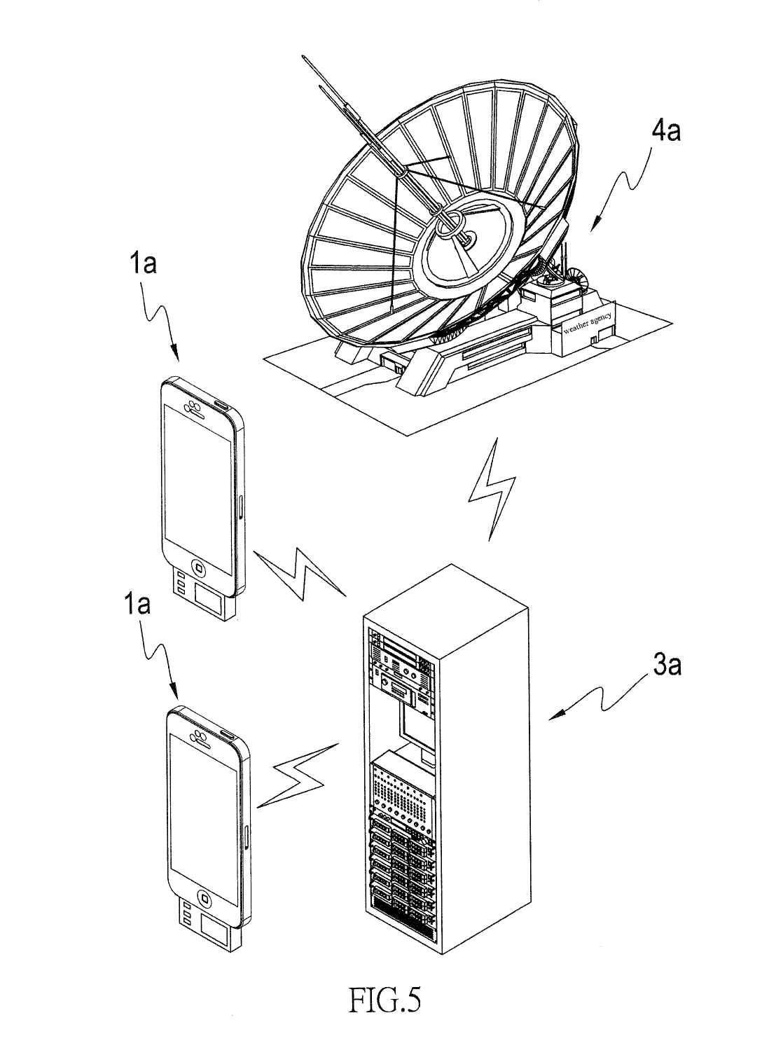

Referring to FIGS. 4 and 5, which are respectively a block diagram and a perspective view of another preferred embodiment of the present invention, these drawings clearly show that the present invention primarily comprises an identification carrier and a portable electronic device 1a in information connection with each other. The identification carrier comprises a temperature/humidity detection device 2a, a transfer module 11a, and a data processing module 3a. The temperature/humidity detection device 2a is mounted on the portable electronic device 1a. The temperature/humidity detection device 2a functions to generate personal temperature/humidity data. The transfer module 11a is mounted in the portable electronic device 1a. The transfer module 11a is set in information connection with the temperature/humidity detection device 2a. What is different from the previous embodiment is that the data processing module 3a is set in information connection with at least one weather agency 4a to acquire temperature/humidity information of each area that is further compared with the personal temperature/humidity data. The data processing module 3a selectively and simultaneously connected with transfer modules 11a built in a plurality of portable electronic devices 1a. The portable electronic devices 1a can acquire positional information through Bluetooth, wireless fidelity (Wi-Fi), or a global positioning system (GPS) so that the transfer modules 11a obtain precise positional information through the portable electronic devices 1a and transmit the positional information to the data processing module 3a, whereby precise temperature and humidity information can be supplied to the user through comparison of the positional information and the personal temperature/humidity data with the temperature/humidity information of each area, subtracting personal temperature/humidity data that excessively deviates from the temperature/humidity information of the area (such as when a user is in an air-conditioned room), and further calculating localized temperature/humidity information through averaging the personal temperature/humidity data in the area.

Thus, the key technical feature that the mobile carrier device capable of identifying local temperature and humidity and the method thereof adopted by the present invention to overcome the drawbacks of the known techniques is as follows:

(1) The collaborative operation among the temperature/humidity detection device 2, the transfer module 11, and the data processing module 3 and the portable electronic device 1 allows the present invention to achieve a practical advantage of being easy to use and providing environment-fit makeup advice.

(2) The collaboration among the temperature/humidity detection device 2a, the transfer module 11a, and the data processing module 3a and the portable electronic device 1a and the weather agency 4a allows the present invention to achieve a practical advantage of preciseness and instantaneity of temperature/humidity and weather.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A mobile carrier device capable of identifying local temperature and humidity, comprising an identification carrier and a portable electronic device in information connection with each other,
wherein the identification carrier comprises:
a temperature/humidity detection device, which is mounted on the portable electronic device and generates personal temperature/humidity data
a transfer module, which is mounted in the portable electronic device and is in information connection with the temperature/humidity detection device; and
a data processing module, which receives the personal temperature/humidity data and feeds suitable makeup information corresponding to the personal temperature/humidity data back to the transfer module.

2. The mobile carrier device capable of identifying local temperature and humidity according to claim 1, wherein the transfer module retrieves precise positional information through the portable electronic device and transmits the positional information to the data processing module.

3. The mobile carrier device capable of identifying local temperature and humidity according to claim 2, wherein the portable electronic device acquires the positional information through Bluetooth, wireless fidelity (W-Fi), a global positioning system (GPS).

4. The mobile carrier device capable of identifying local temperature and humidity according to claim 1, wherein the data processing module is in information connection with at least one weather agency to acquire temperature/humidity information of each area that is compared with the personal temperature/humidity data, the data processing module being selectively connected to a plurality of transfer modules to calculate localized temperature/humidity information.

5. The mobile carrier device capable of identifying local temperature and humidity according to claim 1, wherein the transfer module directly displays the personal temperature/humidity data on the portable electronic device and also displays the makeup information of the data processing module or temperature/humidity information.

6. A method of a mobile carrier capable of identifying local temperature and humidity, which comprises a temperature/humidity detection device that is mounted on a portable electronic device detecting surrounding temperature and humidity, generating and transmitting personal temperature/humidity data to a transfer module mounted in the portable electronic device, the transfer module transmitting the personal temperature/humidity data to a data processing module, and the data processing module feeding suitable makeup information corresponding to the personal temperature/humidity data back to the transfer module for providing advice to a user.

7. The method of a mobile carrier capable of identifying local temperature and humidity according to claim 6, wherein the transfer module retrieves precise positional information through the portable electronic device and transmits the positional information to the data processing module.

8. The method of a mobile carrier capable of identifying local temperature and humidity according to claim 7, wherein the portable electronic device acquires the positional information through Bluetooth, wireless fidelity (W-Fi), a global positioning system (GPS).

9. The method of a mobile carrier capable of identifying local temperature and humidity according to claim 6, wherein the data processing module is in information connection with at least one weather agency to acquire temperature/humidity information of each area that is compared with the personal temperature/humidity data, the data processing module being selectively connected to a plurality of transfer modules to calculate localized temperature/humidity information.

10. The method of a mobile carrier capable of identifying local temperature and humidity according to claim 6, wherein the transfer module directly displays the personal temperature/humidity data on the portable electronic device and also displays the makeup information of the data processing module or temperature/humidity information.
